(19) United States
(12) Patent Application Publication
(10) Pub. No.: US 2025/0229553 A1
(43) Pub. Date: Jul. 17, 2025

(54) ADJUSTMENT MECHANISM AND PRINTER

(71) Applicant: FCL COMPONENTS LIMITED, Tokyo (JP)

(72) Inventors: Sota Ishigaki, Tokyo (JP); Tatsuya Oguchi, Tokyo (JP)

(21) Appl. No.: 19/014,711

(22) Filed: Jan. 9, 2025

(30) Foreign Application Priority Data
Jan. 17, 2024 (JP) 2024-005619

(51) Int. Cl. B41J 15/04; B41J 2/32; B41J 11/00; B41J 11/04

(52) U.S. Cl. CPC B41J 15/046; B41J 2/32; B41J 11/0095; B41J 11/04

(57) ABSTRACT

An adjustment mechanism is provided for allowing spacing between a pair of slide guides to be adjusted. The adjustment mechanism includes: a rail having a slide groove, the rail having a plurality of fitting recesses; and the pair of slide guides arranged to be able to slide in the slide groove, the slide guides having protrusions that fit, and are able to slide, in the fitting recesses. By moving the protrusions out of the fitting recesses, the slide guides are disengaged from the fitting recesses and are able to slide in the slide groove.

### CROSS-REFERENCE TO RELATED APPLICATION

This application is based upon and claims the benefit of priority of Japanese Patent Application No. 2024-005619, filed on Jan. 17, 2024, the entire contents of which are incorporated herein by reference.

### BACKGROUND

A certain aspect of embodiments is related to an adjustment mechanism and a printer.

In a related field of art, there is a paper guide mechanism for a roll paper printer that can bring a pair of paper guides closer to and farther from each other (see, for example, Unexamined Japanese Patent Application Publication No. 2015-150754).

### SUMMARY

According to an embodiment of the present disclosure, an adjustment mechanism for allowing spacing between a pair of slide guides to be adjusted is provided. The adjustment mechanism includes: a rail having a slide groove, the rail having a plurality of fitting recesses; and the pair of slide guides arranged to be able to slide in the slide groove, the slide guides having protrusions that fit, and are able to slide, in the fitting recesses. By moving the protrusions out of the fitting recesses, the slide guides are disengaged from the fitting recesses and are able to slide in the slide groove.

According to the adjustment mechanism of an embodiment of the present disclosure, the spacing between a pair of slide guides can be adjusted and secured with ease, using a relatively simple mechanism.

### BRIEF DESCRIPTION OF THE DRAWINGS

FIG. 1 is a perspective view of a printer according to an embodiment, seen from the front;

FIG. 2 is a cross-sectional view of a printer according to an embodiment, taken along the line A-A in FIG. 1;

FIG. 3 is a perspective view of a printer according to an embodiment, seen from the rear;

FIG. 4 is a perspective view of a paper guide according to an embodiment;

FIG. 5 is a perspective view of a slide guide according to an embodiment;

FIG. 6 is an exploded perspective view of a slide guide according to an embodiment;

FIG. 7A is an X-Z cross-sectional view of a paper guide according to an embodiment;

FIG. 7B is an X-Z cross-sectional view of a paper guide according to an embodiment;

FIG. 8A is a perspective view of a paper guide according to an embodiment;

FIG. 8B is a perspective view of a paper guide according to an embodiment;

FIG. 9A is a diagram for explaining a paper guide holding structure according to an embodiment;

FIG. 9B is a diagram for explaining a paper guide holding structure according to an embodiment;

FIG. 10 is an outer perspective view of a sensor unit according to an embodiment;

FIG. 11A is a plan view of a paper guide, showing an example of installation of a sensor unit according to an embodiment;

FIG. 11B is a plan view of a paper guide, showing an example of installation of a sensor unit according to an embodiment; and

FIG. 11C is a plan view of a paper guide, showing an example of installation of a sensor unit according to an embodiment.

### DESCRIPTION OF EMBODIMENTS

Hereinafter, a description will be given of an embodiment of the present invention with reference to the drawings.

According to the techniques of the related art described above, the mechanism for bringing a pair of paper guides closer to and farther from each other is complex, and furthermore, it is difficult to adjust and secure, with ease, the spacing between the pair of paper guides to a spacing that well suits the width of the paper roll that is used.

### Embodiment

An embodiment of the present disclosure will be described below with reference to the accompanying drawings. Note that, in the following description, the X-axis direction will be referred to as “the front-back direction,” the Y-axis direction will be referred to as “the left-right direction,” the Z-axis direction will be referred to as “the up-down direction,” the positive X-axis direction will be referred to as “the front direction,” the positive Y-axis direction will be referred to as “the right direction,” and the positive Z-axis direction will be referred to as “the upper direction.”

### (Structure of Printer 10)

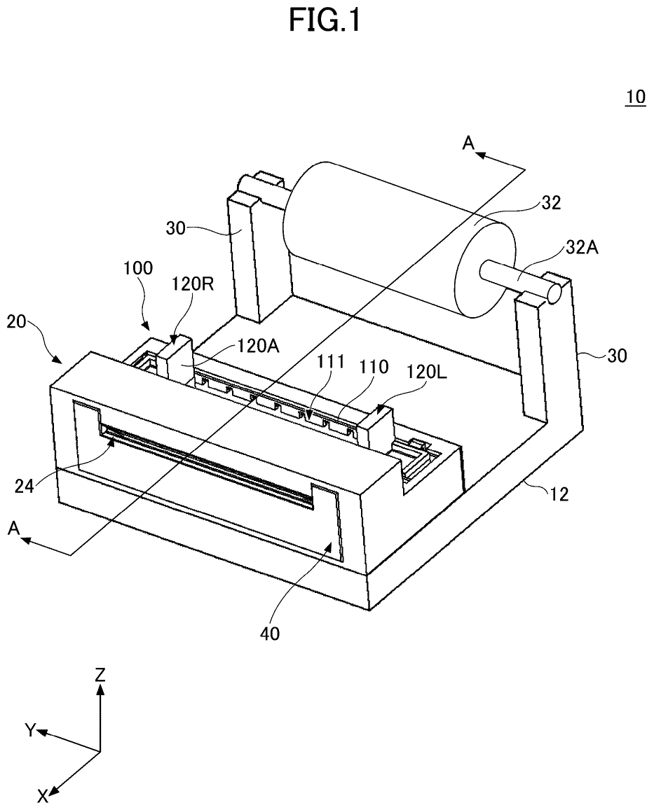

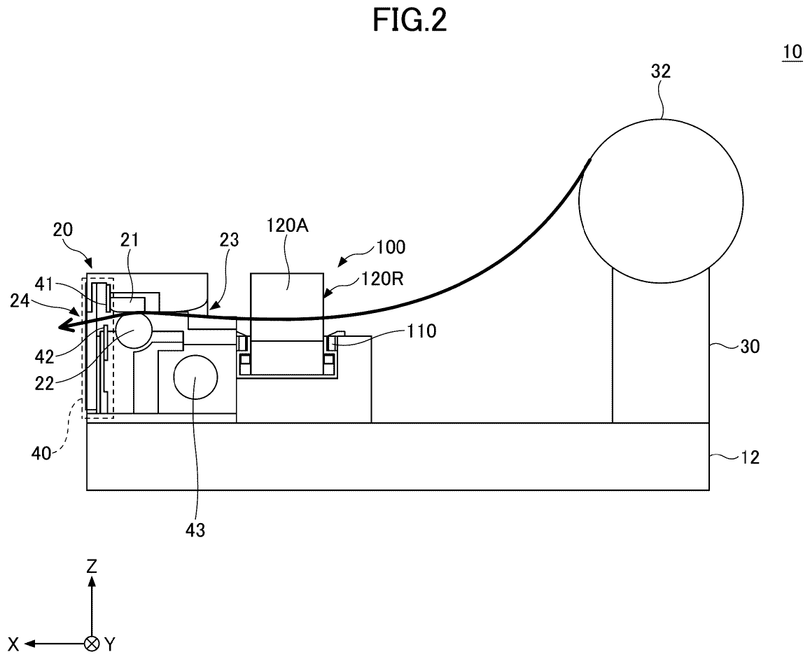

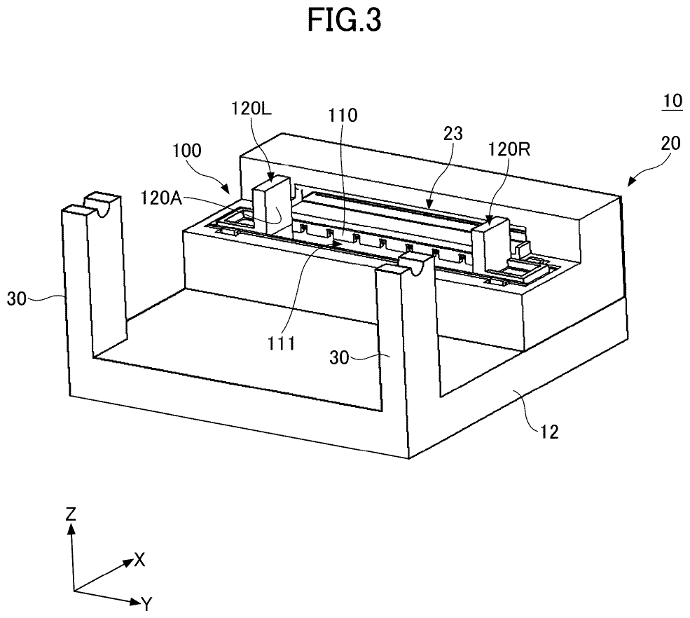

FIG. 1 is an outer perspective view of a printer 10 according to an embodiment, seen from the front. FIG. 2 is a cross-sectional view of the printer 10 according to the embodiment, taken along the line A-A (see FIG. 1). FIG. 3 is an outer perspective view of the printer 10 according to the embodiment, seen from the rear. As shown in FIG. 1 to FIG. 3, the printer 10 has a frame 12, a printer unit 20, and pair of paper roll holders 30.

The frame 12 is a horizontal, flat member. The pair of paper roll holders 30 are provided at the rear of the frame 12 and hold both ends of a core rod 32A of a paper roll 32. Note that the printer 10 can use multiple types of paper rolls 32 of varying paper widths.

The printer unit 20 is provided at the front of the frame 12. The printer unit 20 has a thermal head 21, a platen roller 22, a paper transport motor (not shown), and a cutter motor 43. The thermal head 21 and the platen roller 22 are positioned to face each other vertically. The drive of the paper transport motor (not shown) allows the platen roller 22 to rotate, so that the paper 32 inserted from the paper feed port 23 is carried forward. The thermal head 21 prints on the paper 32 transported thereto.

The printer unit 20 also includes a cutter The cutter unit 40 has a movable blade 42 unit 40. and a fixed blade 41. The cutter motor 43 is driven to move the movable blade 42 toward the fixed blade 41, and the portion of the transported paper 32 printed by the thermal head 21 is cut off between the fixed blade 41 and the movable blade 42. The paper 32 cut off by the cutter unit 40 is discharged from a paper exit port 24.

The printer unit 20 also has a paper guide 100. The paper guide 100 is provided behind the paper feed port 23. The paper guide 100 is an example of an “adjustment mechanism.” The paper guide 100 has a rail 110 that extends straight in the left-right direction, and a pair of slide guides 120L and 120R that can slide in the left-right direction in a slide groove 111 of the rail 110. The rail 110 and the slide guides 120L and 120R are made of resin, for example. Each of the pair of slide guides 120L and 120R has an opposing guide surface 120A above the rail 110. The paper guide 100 adjusts the spacing between the pair of guide surfaces 120A to be equal to the width of the paper roll 32, thereby guiding the paper 32 inserted in the paper feed port 23 not to move diagonally between the pair of guide surfaces 120A. The paper guide 100 can guide multiple types of paper 32 with varying paper widths by adjusting the spacing between the pair of guide surfaces 120A.

### (Structure of Paper Guide 100)

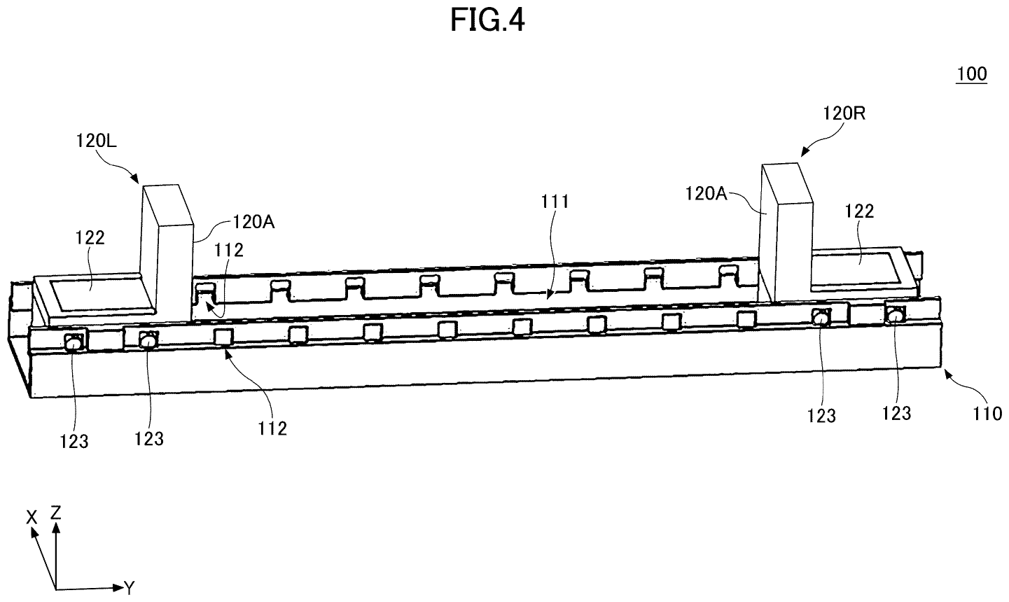

FIG. 4 is an external perspective view of the paper guide 100 according to the embodiment. As shown in FIG. 4, the paper guide 100 has: a rail 110 having a slide groove 111 that extends straight in the left-right direction; and a pair of slide guides 120L and 120R that are arranged such that the slide guides 120L and 120R can slide in the slide groove 111.

The rail 110 has a number of secured positions in the left-right direction, which correspond to the respective widths of multiple types of paper rolls 32 that may be used. The rail 110 can secure the slide guides 120L and 120R at the multiple secured positions. The slide guides 120L and 120R have knobs 123 that can be pressed and operated. By pressing and operating the knobs 123, the slide guides 120L and 120R switch from a state in which the slide guides 120L and 120R are secured at respective secured positions in the rail 110, to a state in which the slide guides 120L and 120R can slide in the slide groove 111 of the rail 110 in the left-right direction.

Each knob 123 has four protrusions 123B that protrude in pairs on respective sides of the slide guides 120L and 120R facing the rail 110. The rail 110 has multiple fitting recesses 112 provided in an upper part of the front wall and multiple fitting recesses 112 provided in an upper part of the rear wall. The four protrusions 123B of the slide guides 120L and 120R engage with the rail 110 at secured positions of choice.

In this state in which the slide guides 120L and 120R are secured to the rail 100 at secured positions of choice, if the knobs 123 are pressed and operated, the four protrusions 123B are all disengaged from the four fitting recesses 112 of the rail 110, and thereupon the slide guides 120L and 120R become capable of sliding in the left-right direction in the slide groove 111 of the rail 110.

Then, in this state in which the knobs 123 are pressed down and the slide guides 120L and 120R are at their respective secured positions of choice in the rail 110, if the press on the knobs 123 is released and the knobs 123 are no longer operated, then the four protrusions 123B engage with the four fitting recesses 112 in the rail 110 from below, and are secured at respective secured positions of choice in the rail 110.

In this way, by pressing and operating the knobs 123, the paper guide 100 according to this embodiment can switch, with ease, between a state in which the slide guides 120L and 120R are secured to secured positions in the rail 110 and a state in which the slide guides 120L and 120R can slide in the slide groove 111 in the left-right direction.

Therefore, the paper guide 100 of the embodiment can adjust and secure, with ease, the spacing between the pair of guide surfaces 120A so as to match the width of the paper roll 32 that is used.

With the paper guide 100 according to the embodiment, the four protrusions 123B engage with the four fitting recesses 112 in the rail 110, at each secured position in the rail 110, thereby reliably securing the slide guides 120L and 120R.

In particular, with the paper guide 100 according to the embodiment, each secured position in the rail 110 is provided at a position to match the width of the paper roll 32 that may be used, so that the spacing between the pair of guide surfaces 120A of the slide guides 120L and 120R can be adjusted and secured with ease to the same size as the width of the paper roll 32 that is used.

### (Structure of Slide Guides 120)

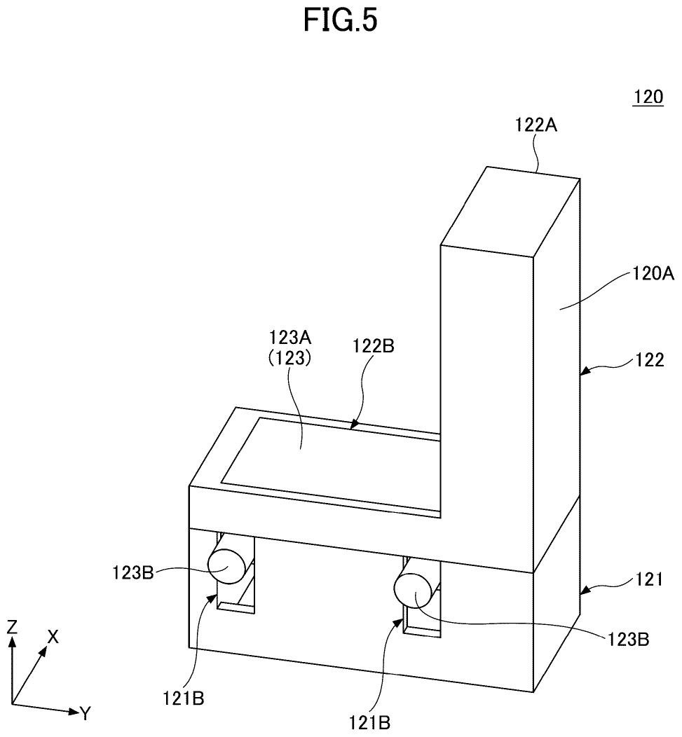

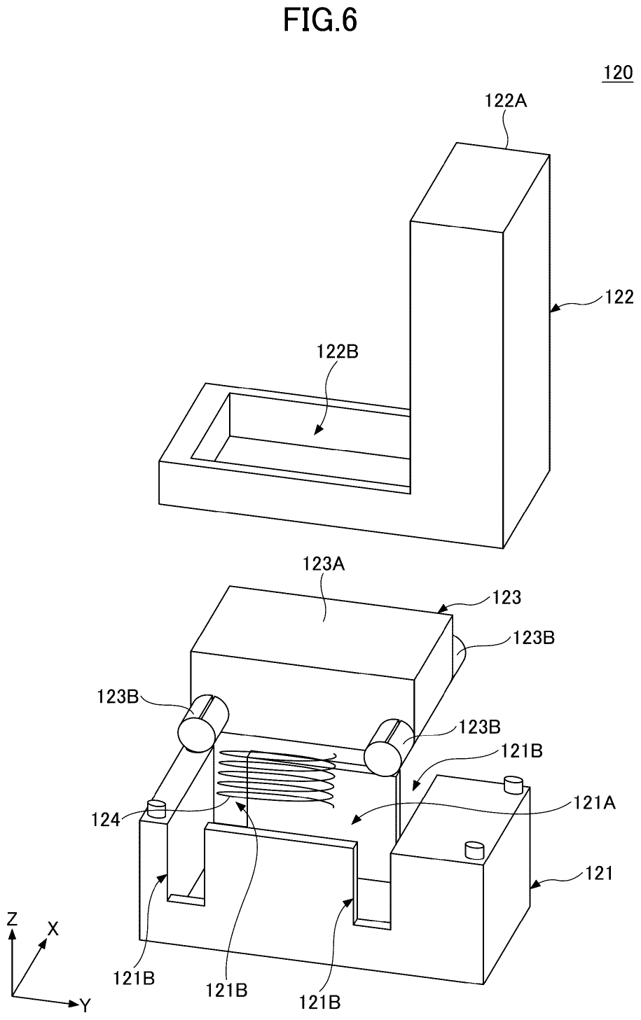

FIG. 5 is an external perspective view of a slide guide 120 according to the embodiment. FIG. 6 is an exploded perspective view of a slide guide 120 according to the embodiment. Note that, since the slide guides 120L and 120R are shaped and structured alike, the slide guide “120” shown in FIG. 5 and FIG. 6 can be either the slide guide 120L or the slide guide 120R.

As shown in FIG. 5 and FIG. 6, a slide guide 120 has a case 121, a cover 122, a knob 123, and a coil spring 124.

The case 121 is a resin member having a rectangular parallelepiped shape. A recess 121A shaped as an open-topped rectangular parallelepiped space is formed in the case 121 below an opening 122B of the cover 122. The knob 123 and the coil spring 124 are arranged inside the recess 121A.

Also, two cutouts 121B are formed in the left-right direction on each of the front wall and the rear wall of the case 121. The cutouts 121B are formed by cutting upper edge parts of the front wall and rear wall of the case 121 downward, with a certain width kept between the two cutouts 121B.

The cover 122 is a resin member that is attached to the case 121 so as to cover the upper part of the case 121. The cover 122 is attached to the case 121, and the knob 123 and the coil spring 124 are positioned inside a recess 121A of the case 121, allowing the knob 123 to be engaged such that the knob 123 can slide along the cutout 121B.

The cover 122 has a guide wall 122A erected vertically, at one end in the Y-axis direction. This makes the cover 122 L-shaped when viewed from the side. The vertical surface on the one Y-axis side of the guide wall 122A and the vertical surface on the corresponding Y-axis side of the case 121 together constitute the guide surface 120A that guides the paper roll 32.

Also, the cover 122 has an opening 122B that is rectangular in shape when viewed from above, at a position to meet the knob 123. The upper part of the knob 123 is positioned in the opening 122B, so that the upper surface 123A of the knob 123 is exposed. For example, the cover 122 is secured to the case 121 by a snap-fit mechanism, a press-fit mechanism, or the like.

The knob 123 is an operating member made of resin, for example, and can be pressed and operated. The knob 123 is arranged inside the recess 121A of the case 121 such that the knob 123 can move in the up-down direction. In this embodiment, as an example, the knob 123 has a rectangular parallelepiped shape. The upper surface 123A of the knob 123 is exposed upward from the opening 122B of the cover 122. This allows the operator to press and make operations on the upper surface 123A of the knob 123 from above.

The knob 123 has two cylindrical protrusions 123B, spaced apart in the left-right direction, on both the front side surface and the rear side surface. The spacing between the two protrusions 123B is equal to the spacing between two adjacent fitting recesses 112 provided at respective secured positions in the rail 110, and to the spacing between two cutouts 121B formed in the same wall part of the case 121.

The protrusions 123B are inserted in the cutouts 121B formed in the front wall and the rear wall of the case 121, and protrude outward beyond the front wall and the rear wall of the case 121. The protrusions 123B slide up and down in the cutouts 121B of the case 121, following the knob 123 that moves up and down.

The coil spring 124 is a metal member. Inside the recess 121A of the case 121, the coil spring 124 is positioned below the knob 123, and preloads the knob 123 upward. When the knob 123 is pressed down and operated, the coil spring 124 is compressed by the knob 123. Then, when the press on the knob 123 is released and the knob 123 is no longer operated, the coil spring 124 moves the knob 123 upward by its own elastic force, allowing the knob 123 to automatically resume its initial position. Note that the coil spring 124 can be replaced with other elastic members such as a leaf spring, rubber, and so forth.

### (Operation of Slide Guides 120)

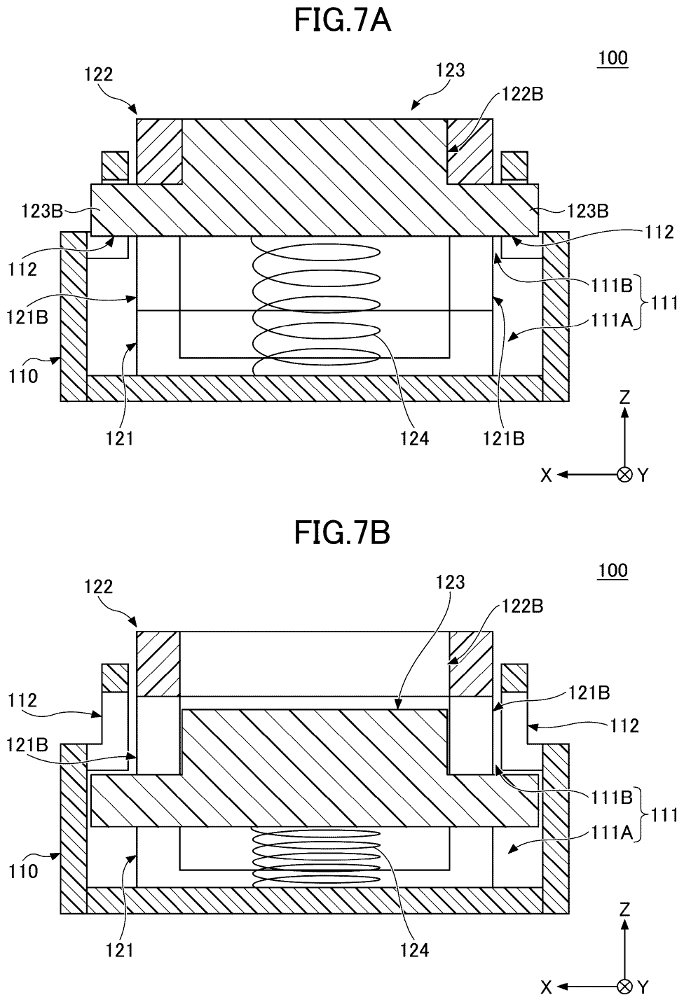

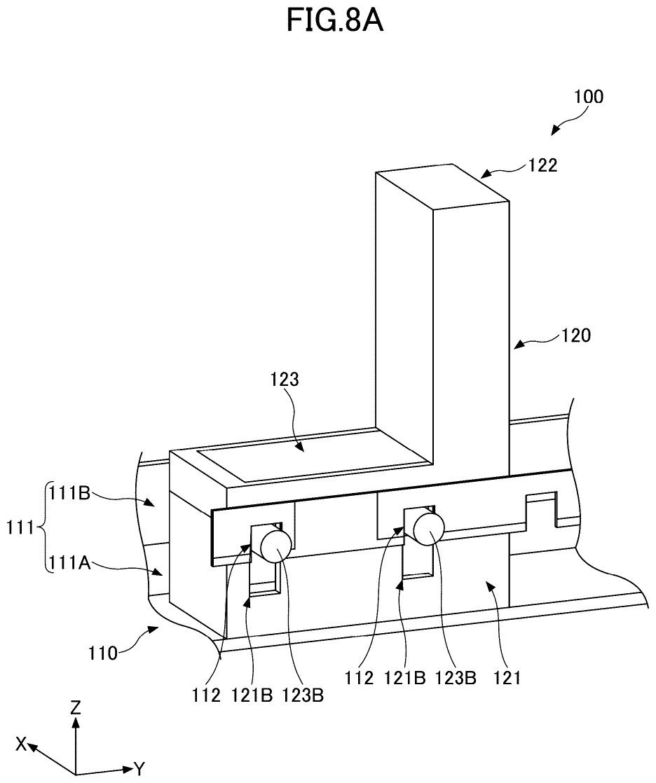

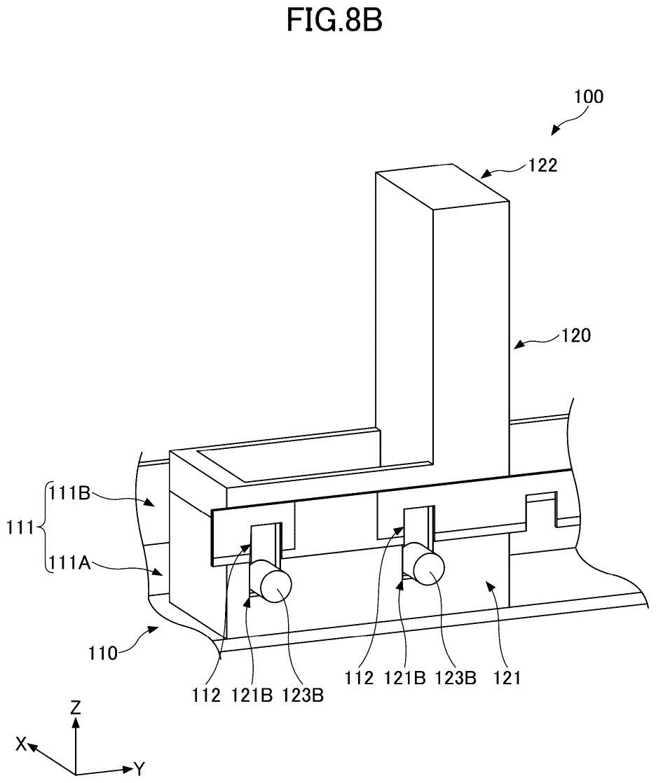

FIG. 7A and FIG. 7B are X-Z cross-sectional views of the paper guide 100 according to the embodiment. FIG. 8A and FIG. 8B are perspective views in which a part of the rear side wall of the rail 110 of the paper guide 100 of the embodiment is made transparent. FIG. 7A and FIG. 8A both show a state in which the knob 123 is not pressed. FIG. 7B and FIG. 8B both show a state in which the knob 123 is pressed.

As shown in FIG. 7A and FIG. 7B, the slide groove 111 of the rail 110 is a groove that is open at the top and extends in the left-right direction. The slide groove 111 has a wide part 111A and a narrow part 111B. The wide part 111A is provided on the lower side and has a second width. The narrow part 111B is provided on the upper side and has a first width, which is narrower than that of the wide part 111A.

The width of the wide part 111A of the slide groove 111 is wider than the width of the knob 123 including the protrusions 123B. Therefore, as shown in FIG. 7B and FIG. 8B, when the knob 123 is pressed down and the four protrusions 123B of the knob 123 all move downward in the cutouts 121B of the case 121 and enter the wide part 111A, the slide guides 120 switch to a state in which the slide guides 120 can slide in the slide groove 111 of the rail 110 in the left-right direction.

On the other hand, the width of the slide groove 111 in the narrow part 111B is narrower than the width of the knob 123 including the protrusions 123B. Consequently, when the slide guide 120 is located at positions other than the secured positions in the rail 110, the protrusions 123B of the knob 123 hit the bottom of the narrow part 111B, and the upward movement of the knob 123 is restricted. Accordingly, the slide guide 120 maintains a state in which the slide guide 120 can slide in the slide groove 111 of the rail 110 in the left-right direction.

Then, when the slide guide 120 is located at a predetermined secured position in the rail 110, as shown in FIG. 7A and FIG. 8A, the four protrusions 123B of the knob 123 all move upward in the cutouts 121B of the case 121 and enter the four fitting recesses 112 formed in the front inner wall surface and the rear inner wall surface of the narrow part 111B from below. As a result of this, the knob 123 moves upward under the preloaded force from the coil spring 124. Consequently, the slide guide 120 is secured at a predetermined secured position, and its ability to slide in the left-right direction is restricted.

### (Mechanism for Holding Paper Guide 100)

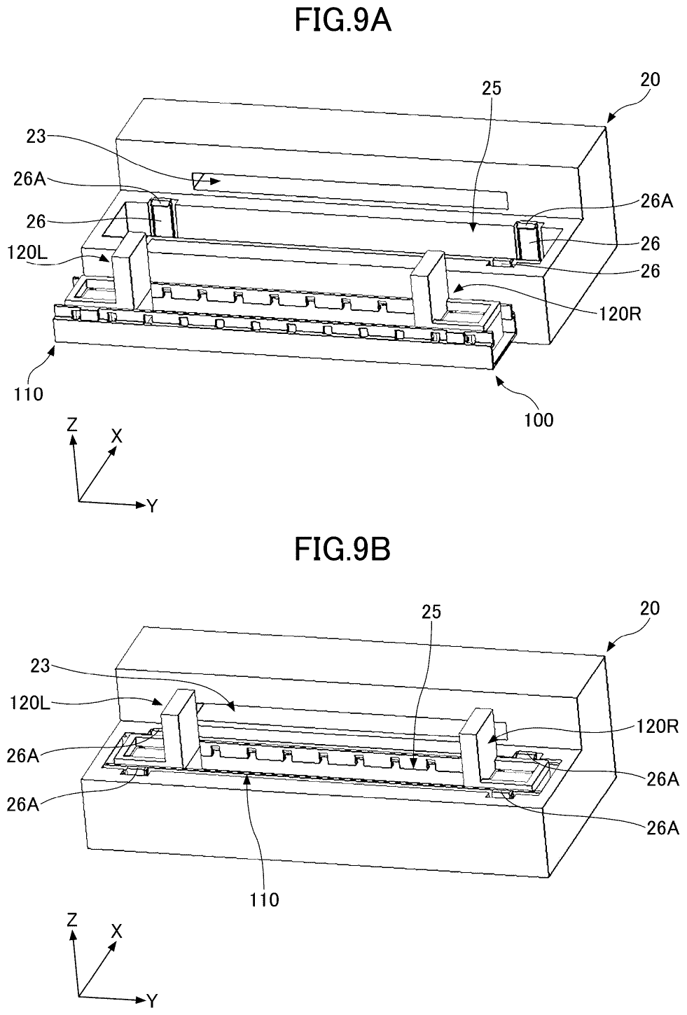

FIG. 9A and FIG. 9B are diagrams for explaining a mechanism for holding the paper guide 100 according to an embodiment. FIG. 9A is a perspective view of the printer unit 20 and the paper guide 100 in a disassembled state. FIG. 9B is a perspective view of the printer unit 20 and the paper guide 100 in an assembled state.

As shown in FIG. 9A and FIG. 9B, in the printer unit 20, a holder 25 is provided behind the paper feed port 23. The shape of the holder 25 is recessed in substantially the same shape as the outer shape of the rail 110 of the paper guide 100. In addition, two elastic arms 26 are spaced apart in the left-right direction, on each of the front inner wall surface and the rear inner wall surface of the holder 25. The lower end of each elastic arm 26 is secured, so that each elastic arm 26 can be deformed elastically in the front-back direction. Each elastic arm 26 has, at its upper end, an engagement claw 26A that protrudes toward the inside of the holder 25.

As shown in FIG. 9A and FIG. 9B, the paper guide 100 can be attached to and detached from the holder 25. The rail 110 elastically deforms the four elastic arms 26, and, as shown in FIG. 9B, the rail 110 is fitted in the holder 25, so that the paper guide 100 is held by the holder 25. At this time, the engagement claws 26A of the four elastic arms 26 engage with front upper edge parts and rear upper edge parts of the rail 110, so that the paper guide 100 is secured so as not to slip out of the holder 25. Then, when the engagement claws 26A of the four elastic arms 26 are disengaged from the upper edge of the rail 110, the paper guide 100 can be removed from the holder 25.

Note that, although the rail 110 is secured to the holder 25 by a snap-fit mechanism using the elastic arms 26 in this embodiment, the present disclosure is by no means limited to this, and, in other examples, the rail 110 may be secured to the holder 25 by screwing or the like. Also, the rail 110 and the printer unit 20 need not be separate parts, and may be formed integrally as well.

### (Structure of Sensor Unit 130)

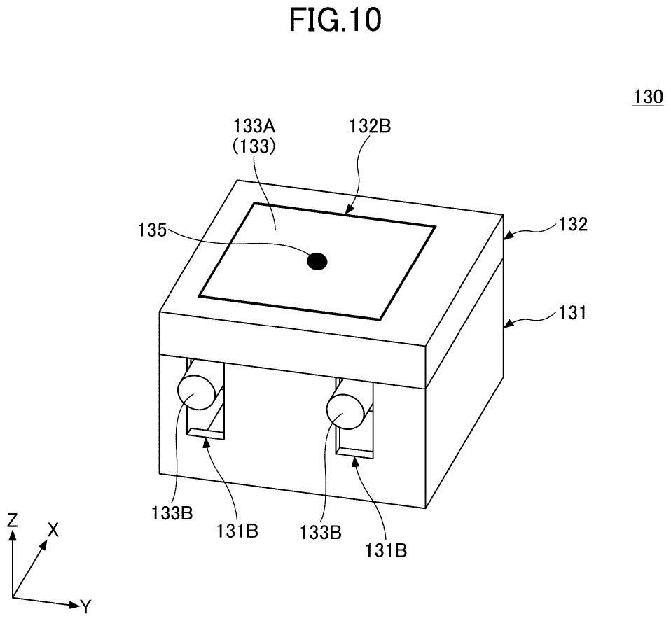

FIG. 10 is an external perspective view of the sensor unit 130 according to the embodiment. As shown in FIG. 10, the sensor unit 130 includes a case 131, a cover 132, a knob 133, and a coil spring 134 (not shown). The case 131 and the coil spring 134 are the same as the case 121 and the coil spring 124 of the slide guide 120, and therefore their description will be omitted.

The cover 132 is different from the cover 122 of the slide guide 120 in that the former does not have a guide wall 122A. The rest of the cover 132 is the same as the cover 122 of the slide guide 120 and therefore will not be described again.

Like the knobs 123 of the slide guide 120, each knob 133 has four protrusions 133B. By pressing and operating the knobs 133, the four protrusions 133B slide in the up-down direction in the cutouts 131B of the case 131. A knob 133 is different from a knob 123 in that the former has, on its upper surface 133A, a sensor 135 for detecting paper 32. The rest of the knob 133 is the same as the knob 123 of the slide guide 120 and therefore will not be described again.

### (Example of Installation of Sensor Unit 130)

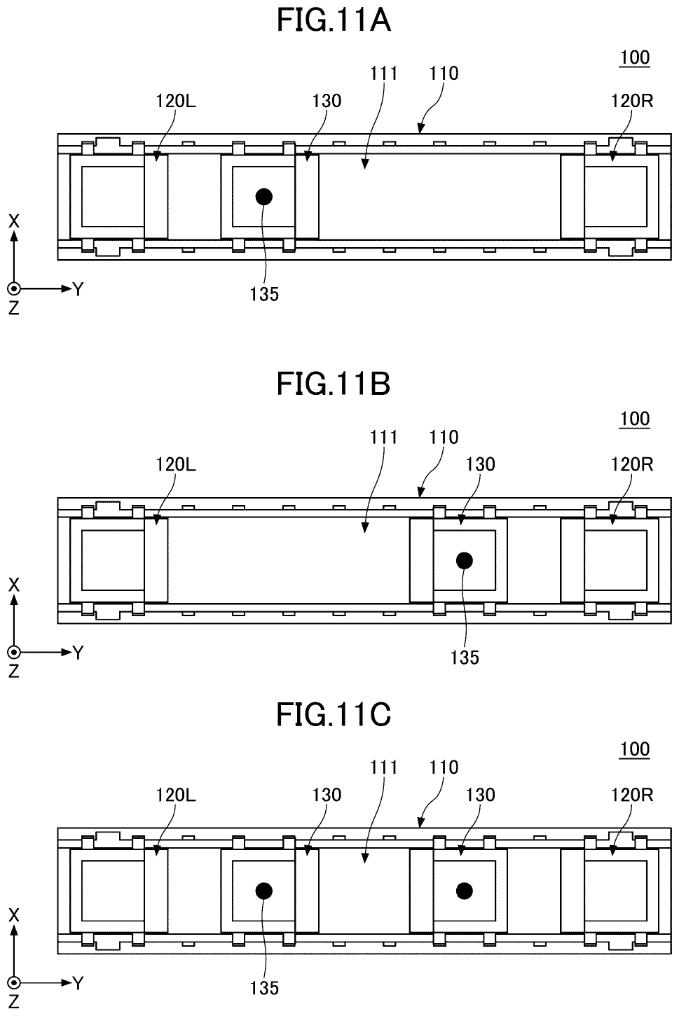

FIGS. 11A, 11B, and 11C are plan views of the paper guide 100, showing examples of installation of the sensor unit 130 according to an embodiment.

In the example shown in FIG. 11A, the sensor unit 130 is secured at one secured position between slide guides 120L and 120R in a slide groove 111 of a rail 110.

Also, in the example shown in FIG. 11B, the sensor unit 130 is secured at another secured position between the slide guides 120L and 120R in the slide groove 111 of the rail 110.

Furthermore, in the example shown in FIG. 11C, two sensor units 130 are secured at two secured positions between the slide guides 120L and 120R in the slide groove 111 of the rail 110.

Note that both ends of the slide groove 111 in the rail 110 in the left-right direction are open. As a result of this, the slide guide 120 and sensor unit 130 can be attached to and detached from the inside of the slide groove 111, from both ends of the slide groove 111, while the knobs 123 and the knobs 133 are pressed down.

In this way, with the paper guide 100 according to an embodiment, as has been described earlier with the slide guide 120, one or more sensor units 130 can be provided in the slide groove 111 of the rail 110 such that the one or more sensor units 130 can slide in the left-right direction.

By pressing down the knobs 133, the sensor unit 130 of the embodiment can be switched with ease between a state in which the sensor unit 130 is secured at a secured position in the rail 110 and a state in which the slide sensor unit 130 can slide in the left-right direction in the groove 111. This allows the paper guide 100 according to an embodiment to adjust and secure with ease the position where the sensor 135 detects the paper 32.

Also, with the paper guide 100 according to an embodiment, at every secured position in the rail 110, the four protrusions 133B of each knob 133 of the sensor unit 130 engage with four fitting recesses 112 of the rail 110, respectively, allowing the sensor unit 130 to be secured to the rail 110 in a more reliable fashion.

Although an embodiment of the present disclosure has been described above in detail, it should be understood that various changes, substitutions, and alterations can be introduced to what is described herein, without departing from the spirit and scope of the present disclosure as set forth in the claims attached herewith.

For example, the platen roller 22, the movable blade 42, and the cutter motor 43 may be attached and detached forward, with respect to the thermal head 21, the paper transport motor (not shown), and the fixed blade 41.

Also, for example, the protrusions 123B may be polygonal-columnar or flat in shape, and the number of protrusions that a knob 123 has may be two instead of four.

For example, coil springs may be provided inside the slide groove 111 of the rail 110, and the sliding of the slide guide 120 may be caused by preloading by the elastic force of the coil springs.

In one example, coil springs may be provided outside with respect to the slide guides 120L and 120R in the slide groove 111, to provide a preloading force that causes the sliding of the slide guides 120L and 120R inward.

Also, in another example, coil springs may be provided inside with respect to the slide guides 120L and 120R in the slide groove 111, to provide a preloading force that causes the sliding of the slide guides 120L and 120R outward.

Also, in another example, coil springs may be provided inside and outside with respect to the slide guides 120L and 120R in the slide groove 111, to provide a preloading force that causes the sliding of the slide guides 120L and 120R outward and inward.

Also, “the adjustment mechanism” according to the present disclosure is not limited to being applied to a paper guide in a printer, and may be applied to any other device that can at least adjust the spacing between a pair of slide guides (for example, a holder device that holds a smartphone or the like between a pair of slide guides).

All examples and conditional language provided herein are intended for the purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An adjustment mechanism for allowing spacing between a pair of slide guides to be adjusted, the adjustment mechanism comprising:
a rail having a slide groove, the rail having a plurality of fitting recesses; and
the pair of slide guides arranged to be able to slide in the slide groove, the slide guides having protrusions that fit, and are able to slide, in the fitting recesses,
wherein, by moving the protrusions out of the fitting recesses, the slide guides are disengaged from the fitting recesses and are able to slide in the slide groove.

2. The adjustment mechanism according to claim 1, wherein the pair of slide guides each have a knob with the protrusions and an elastic member that preloads the knob in a direction in which the protrusions slide in the fitting recesses.

3. The adjustment mechanism according to claim 1,
wherein the rail includes:
a narrow part having the fitting recesses and having a first width; and
a wide part having a second width that is wider than the first width, and
wherein, by moving the protrusions to the wide part, the slide guides are able to slide in the slide groove.

4. A printer comprising:
a thermal head;
a platen roller; and
a paper guide including a pair of slide guides and allowing spacing between the slide guides to be adjusted, the paper guide including:
a rail having a slide groove, the rail having a plurality of fitting recesses; and
the pair of slide guides arranged to be able to slide in the slide groove, the slide guides having protrusions that fit, and are able to slide, in the fitting recesses,
wherein, by moving the protrusions out of the fitting recesses, the slide guides are disengaged from the fitting recesses and are able to slide in the slide groove.

5. The printer according to claim 4, further comprising a sensor unit arranged to be able to slide in the slide groove, the sensor unit having protrusions that fit, and are able to move, in the fitting recesses,
wherein, by moving the protrusions out of the fitting recesses, the sensor unit is disengaged from the fitting recesses and is able to slide in the slide groove.
